(19) United States
(12) Patent Application Publication
(10) Pub. No.: US 2022/0234551 A1
(43) Pub. Date: Jul. 28, 2022

(54) MULTI-FUNCTIONAL WHEEL CHOCK

(71) Applicant: Adam S. Laudick, Coshocton, OH (US)

(72) Inventor: Adam S. Laudick, Coshocton, OH (US)

(21) Appl. No.: 17/580,780

(22) Filed: Jan. 21, 2022

Related U.S. Application Data
(60) Provisional application No. 63/140,410, filed on Jan. 22, 2021.

(51) Int. Cl. B60T 3/00

(52) U.S. Cl. CPC B60T 3/00

(57) ABSTRACT

A device for combining with a vehicle to prevent movement of a wheel. Multiple links are pivotably connected in series and in a loop. In the loop configuration, two spans of the loop may be placed at an angle to one another between a few degrees and 30 to 60 degrees. A third span may connect the first two spans to form a triangle or another shape that may be placed with a first span resting on the surface the wheel is resting on and the second span in contact with the wheel. A third span may connect the other spans. A pin may be removed from the links and disposed in an un-looped configuration for use under a wheel on a low traction surface, such as snow or mud. The links may be rolled up for storage or attached to a vehicle and used as a mud flap.

### BACKGROUND OF THE INVENTION

The present disclosure relates, in general, to a device used to deliberately obstruct the motion of vehicles and any apparatus that has a wheel or rolling structure that may desirably be prevented from movement.

Vehicles, such as cars, trucks, airplanes, military vehicles and trailers, have wheels that roll along a surface upon which they rest, such as pavement, gravel, sand or soil. Such vehicles typically have transmissions, brake systems and/or other mechanical devices that prevent rolling when the vehicle is stopped for a long period. However, it is desirable for vehicles without such mechanisms to be prevented from rolling along the ground, or to reduce the probability of rolling by those with one or more of such mechanisms that may fail. Vehicles with roll-preventing mechanisms sometimes desirably need a backup to such mechanisms, such as on hills or when severe damage or injury would occur upon rolling. A wheel chock is a common device for preventing the rolling of a wheel on a vehicle.

Typical wheel chocks are wedge-shaped blocks of material, such as wood, metal or plastic, normally with no moving or movable parts. Wheel chocks essentially occupy space, and their two objectives are (1) to provide a sufficient obstacle to the wheel so that the wheel does not roll past the chock, and (2) to stay under a wheel or other structure that tends to roll in the direction of the chock. That is, under the first objective, the chock should be tall enough that, in position, it requires more force for the wheel to roll over the chock than is applied to the vehicle. Under the second objective the wheel should not “squirt” the chock out of position so that the chock is no longer in place under the wheel in the direction of rolling.

### SUMMARY OF THE INVENTION

Disclosed herein is a device combined with a vehicle wheel resting on a surface. The combination comprises the device, which is defined by multiple links, each of which has opposing sides pivotably mounted to other of the links. The links form a continuous loop including a first span that includes a first group of the links, wherein at least one of the links in the first group is in contact with the surface. The continuous loop includes a second span that includes a second group of the links, wherein at least one of the links in the second group is in contact with the wheel and one of the links of the second span is connected to one of the links of the first span.

Some embodiments may have a third span including a third group of the links connected between the first span and the second span. Some embodiments may have a third span including a third group of the links, at least one of the links in the third group is in contact with a second wheel of the vehicle.

Disclosed herein is an apparatus configurable to obstruct a wheel on a vehicle. The apparatus comprises at least first, second, third and fourth links connected to form a loop. Each of the links includes a plate, at least one knuckle on a first side of the plate and at least one knuckle on a second, opposite side of the plate. The first link is pivotably connected to the second link in the loop by a first pin extending through the at least one knuckle on the second side of the first link and the at least one knuckle on the first side of the second link. The second link is pivotably connected to the third link in the loop by a second pin extending through the at least one knuckle on the second side of the second link and the at least one knuckle on the first side of the third link.

Disclosed herein is a method of obstructing a vehicle wheel that rests on a surface. The method comprises connecting multiple links in series forming a continuous loop, each of the links having opposing sides pivotably mounted to other of the links. The method also comprises forming a first span including a first group of the links and placing at least one of the links in the first group in contact with the surface. The method also comprises forming a second span including a second group of the links and placing at least one of the links in the second group in contact with the wheel. In some embodiments, the method further comprises forming a third span including a third group of the links connected between the first span and the second span. In some embodiments, the method further comprises forming a third span including a third group of the links and disposing at least one of the links in the third group in contact with a second wheel of the vehicle.

Disclosed herein is a wheel chock that is a tool primarily used for securing a vehicle, such as a car, truck, airplane, military vehicle and/or trailer (including wheels that support the main weight of the trailer and/or a tongue jack wheel used typically for stationary or slow movement support) from unwanted rolling movement along a surface upon which the vehicle rests, such as pavement, gravel, sand, soil or any other material. The wheel chock can be produced from one or more different materials, including at least plastic, steel, aluminum, ceramic or any suitable composite. A plastic wheel chock may be made by injection molding, optionally with glass or carbon fiber reinforcement for proper strength. Nylon and other polymers may be used.

The wheel chock disclosed herein is a multi-functional device made up of several moving parts with several configurations, which affect their positions during use. In the “Wedge” configuration (FIG. 1), a chock may be placed in front of or behind a wheel, and then the wheel may be deliberately driven over the chock to move one or more components of the chock. For example, the chock's upper span moves horizontally (from the position shown in FIG. 1) relative to the lower span (to the position shown in FIG. 2). After moving, the upper span assumes a concave shape as shown in FIG. 2. In this FIG. 2 “Cradle” configuration, the wheel must roll over a higher portion on both ends of the chock to roll in either direction past the chock. The chock thereby keeps the vehicle secured in place by the weight of the vehicle maintaining the chock's end obstacles, which resist rolling of the wheel, in place.

The “Trailer” configuration (FIG. 5) is for securing tandem axle trailers or any other vehicle with wheels positioned close together as shown. After the chock has been formed in a triangular shape shown in FIG. 5, it is placed between the tandem wheels as shown. The chock thus obstructs movement of the vehicle forward as well as backward.

In the “Traditional” configuration (FIG. 6), the wheel chock is in a familiar wedge shape, similar to conventional wheel chocks that are formed of a block of plastic or wood. The chock in this configuration may be placed against the front or back of a wheel, with the narrow chock tip between the wheel and the ground. In this configuration, the chock secures the vehicle from rolling past the taller distal end of the chock.

In the “Pull Pin Layout” configuration (FIG. 4), the device adds traction to stuck vehicles so they can be driven out of sand, snow, mud or other slippery or unstable terrain. In order to configure the device for additional traction, one may pull out a connecting pin from the chock to un-loop the chock, unroll the series of links of the chock, and place the links under (or in the desired direction of travel of) the stuck tire or tires. Many similarly configured chocks may be strung together as needed to drive the vehicle to stable ground.

### BRIEF DESCRIPTION OF THE DRAWINGS

FIG. 1 is a side view illustrating an embodiment of the present invention in an operable configuration and in an operable position relative to a wheel.

FIG. 2 is a side view illustrating the embodiment of FIG. 1 after the wheel has rolled up onto the structure and after the upper span has shifted to a different position than shown in FIG. 1.

FIG. 3 is a view in perspective illustrating an embodiment of the invention over which a vehicle wheel may drive to gain traction.

FIG. 3B is a view in perspective illustrating an embodiment of the present invention in an alternative configuration.

FIG. 4 is a view in perspective illustrating an embodiment of the invention in an open configuration to illustrate the components of the device.

FIG. 5 is a view in perspective illustrating an embodiment of the invention in an operable position between two wheels.

FIG. 6 is a view in perspective illustrating an embodiment of the invention in an operable configuration and in an operable position relative to a wheel.

FIG. 7 is a view in perspective illustrating an embodiment of the invention stored relative to a wheel in the manner of a mud flap.

In describing the preferred embodiment of the invention which is illustrated in the drawings, specific terminology will be resorted to for the sake of clarity. However, it is not intended that the invention be limited to the specific term so selected and it is to be understood that each specific term includes all technical equivalents which operate in a similar manner to accomplish a similar purpose. For example, the word connected or terms similar thereto are often used. They are not limited to direct connection, but include connection through other elements where such connection is recognized as being equivalent by those skilled in the art.

### DETAILED DESCRIPTION OF THE INVENTION

Patent application Ser. No. 63/140,410, filed Jan. 22, 2021, which is the above claimed priority application, is incorporated in this application by reference.

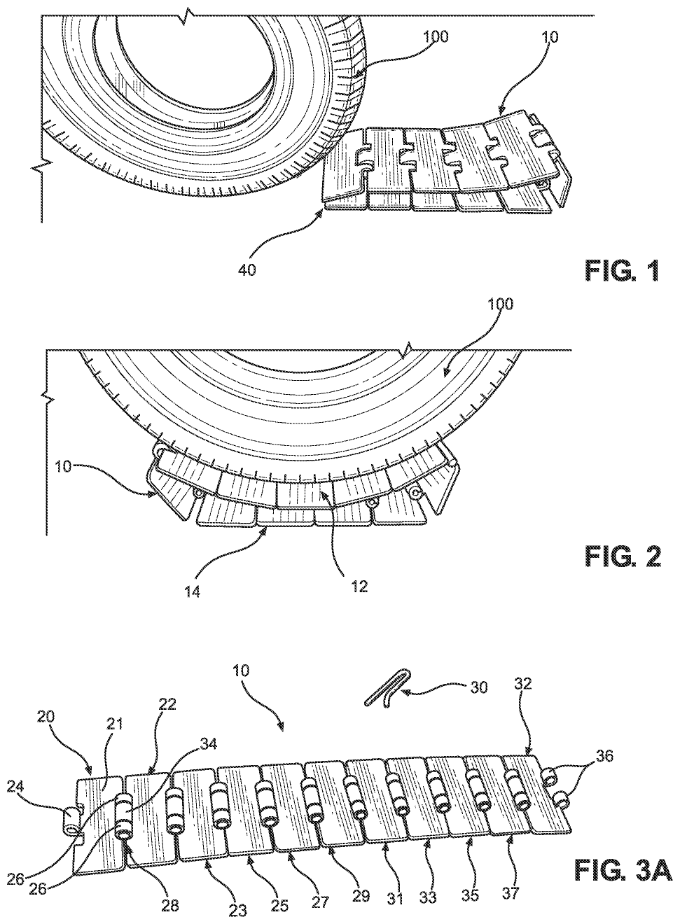

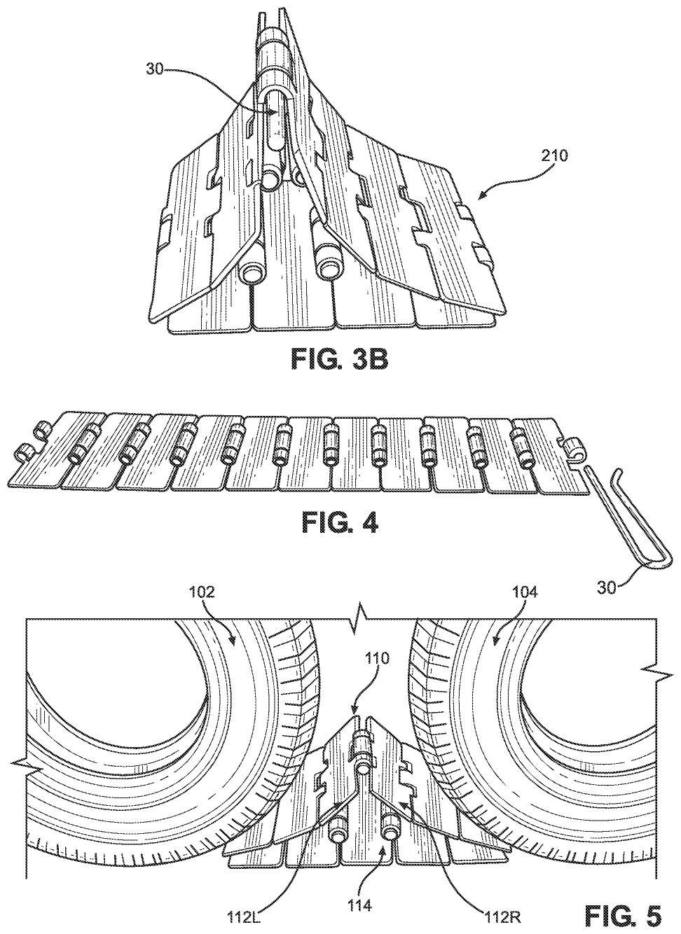

The wheel chock 10 shown in FIGS. 1-3 may be used to prevent the rolling of a wheel on a vehicle or trailer past a desired location. As shown in FIG. 3, the chock 10 has multiple links 20, 22, 23, 25, 27, 29, 31, 32, 33, 35, and 37 that are essentially identical and are pivotably attached to one another in series. Each of the links 20, 22, 23, 25, 27, 29, 31, 32, 33, 35, and 37 is preferably substantially identical, although some small variations common in mass production may exist. Embodiments are also contemplated in which not all of the links are substantially identical, but vary in ways that result in advantages. For example, in an alternative embodiment, about half of the links may be wider than the other half. Each of the links is preferably metal, such as steel, but could alternatively be aluminum, plastic, fiber-reinforced plastic or another composite, ceramic or any other suitable materials.

The link 20 will be described as exemplary of all of the links 22, 23, 25, 27, 29, 31, 32, 33, 35, and 37. Each of the links 22, 23, 25, 27, 29, 31, 32, 33, 35, and 37 has the features described for the link 20 unless noted otherwise. The link 20 has a substantially planar plate 21, which is shown as substantially rectangular in the illustrations but may be other shapes. The plate 21 has a single knuckle 24 rigidly mounted to and protruding from one long side, and a double knuckle 26 rigidly mounted to and protruding from the opposite long side. Each of the knuckles is preferably a body with a cylindrical exterior and an interior void defined by a cylindrical surface that is aligned coaxially with the cylindrical exterior. Such knuckles are similar to the knuckles on door hinges, and the plate 21 is similar to the leaf of a door hinge. The double knuckle 26 may engage a single knuckle 34 of the adjacent link 22, and in the same manner every double knuckle of every link may engage a single knuckle of an adjacent link.

A substantially cylindrical pin 28 may insert through the aligned double knuckle 26 of the link 20 and the single knuckle 34 of the link 22, thereby connecting the links 20 and 22 in a manner that permits the links 20 and 22 to pivot relative to one another about an axis of the pin 28. Similar pins may be inserted in the aligned knuckles of every adjacent link, thereby disposing the links of FIG. 3 in series as shown so that every link may pivot relative to every adjacent, pivotably-mounted link. The pins may be retained therein by friction, such as by the diameter of the interior voids of the double knuckles being the same as the diameter of the outer surface of the pins, thereby creating a friction fit when the pin is driven axially into the opening in the aligned knuckles. Pivoting may be enabled by the diameters of the interior voids of the single knuckles being slightly larger than the diameter of the outer surface of the pins.

A removable pin 30 may extend through the single knuckle 24 and the aligned double knuckle of the distal link 32 with a lower amount of friction fit than the pins 28 in order to dispose the chock 10 in the form of a continuous loop as shown in FIGS. 1-2 and 3B. The removable pin 30 may have a U-shape, as shown in FIGS. 3 and 3B, for easy grasping by human hands or tools (such as pliers), in order that the pin 30 may be removed by hand when desired. Whenever the pin 30 is completely removed from the knuckles 24 and 26, the chock 10 may be disposed again in the open, i.e., non-loop, configuration shown in FIG. 3. Such a series of links may be placed under (or in front or back of) a wheel to enhance traction on snow, sand, mud or any other low traction surface. The open configuration of links shown in FIG. 3 can alternatively be rolled into a roughly cylindrical shape for compact storage, thereby taking up less space than a conventional chock of a similar usage size.

The chock 10 can thus be formed into a continuous loop, which is defined as a series of pivotably joined links disposed in a closed shape, such as a circle, ellipse or random closed shape, in the manner of a bicycle transmission chain. The chock 10 can then be “un-looped” for storage or other reasons as shown in the illustrations and described herein. When the chock 10 is configured in a continuous loop, it may be arranged in a variety of shapes due to the pivoting connection between adjacent, rigid links. As defined herein, the term “rigid” may be used to describe links, and refers to the lack of distortion (bending, twisting, etc.) of the links when used as described herein. Something that is rigid is not defined as impossible to distort by applying a force, but a rigid body will not distort enough during normal use to make use in one of the embodiments disclosed herein unsafe, impractical or otherwise undesirable.

One contemplated shape is a “wedge” shown in FIG. 1 positioned on top of, and in contact with, the ground surface that the wheel is resting on, and having a “sharp” left (in the orientation of FIG. 1) end 40 that is partially beneath a wheel 100 with some of the links in the span contacting the wheel 100. Such a configuration in this position may prevent movement of the wheel 100 relative to the chock 10 to the right in the orientation of FIG. 1, because it obstructs the movement of the wheel on the ground surface.

In another configuration starting with the same FIG. 1 configuration, the wheel 100 may roll onto the left end (in the orientation of FIG. 1) of the chock 10 at its narrowest region, and then roll further toward the taller right end of the chock 10. During the movement of the wheel 100 onto the chock 10, the upper span 12 of links may shift to the right (relative to the lower span 14) to the position shown in FIG. 2. The chock 10 in FIG. 2 forms a “cradle” configuration that obstructs rolling of the wheel 100 from the wheel position shown in FIG. 2 in either direction (to the right and to the left in the FIG. 2 orientation) due to the higher ends of the chock 10 in this configuration.

The shifting of the upper span 12 relative to the lower span 14 occurs when the wheel 100 is rolled onto the left end of the chock 10 in the configuration shown in FIG. 1. As the wheel 100 advances to the right, the upper span 12 shifts to the right relative to the lower span 14. The shifting of the upper span 12 of the chock 10 occurs despite substantial downward weight exerted by the wheel 100 onto the upper span 12 and contact between the upper and lower spans 12 and 14. Shifting occurs despite these circumstances because the downwardly-facing knuckles on the upper span 12 of the looped configuration chock 10 have an exterior shape that is rounded, as described above and shown in FIG. 3. There are similar, upwardly-facing rounded knuckles on the lower span 14 of links that the downwardly-facing knuckles of the upper span 12 rest against. This configuration provides a “shiftable” condition when the links are in the wedge-shape shown in FIG. 1, because, as shown in FIG. 1, the knuckles of the upper span are essentially on the top of the knuckles of the lower span.

When the wheel 100 rolls onto the wedge shape shown in FIG. 1, the rounded knuckles of the upper span 12 that are in contact with the knuckles of the lower span 14 readily shift due to the weight and the instability of the upper span 12 in the configuration shown in FIG. 1, thereby moving the upper span 12 so the chock 10 achieves the cradle shape shown in FIG. 2. Once the upper span 12 is in the position of FIG. 2, it is more difficult to move the upper span 12 relative to the lower span 14 back to the position of the wedge shape shown in FIG. 1, because the knuckles of the upper span 12 are between the knuckles of the lower span 14 when in the shape shown in FIG. 2, which is a stable position, and the weight of the wheel 100 tends to retain them there.

Once in the configuration shown in FIG. 2, more torque (or another force applied by or to the vehicle) is required to move the wheel 100 over the raised ends of the chock 10 at each end shown in FIG. 2. It is difficult for the wheel 100 to move over the raised ends, and it is difficult to shift the upper span 12 of links relative to the lower span 14 to form the wedge shape of FIG. 1 in order to permit the wheel to simply roll off the chock 10. Shifting of upper span 12 relative to the lower span 14 to cause movement from the wedge shape to the cradle shape occurs readily as the wheel 100 is driven onto the chock 10. However, when the weight of a vehicle is on the upper span 12 of links after the upper span 12 has shifted to the cradle configuration, shifting to the left requires more force. Typically, the wedge shape is only attained after the wheel 100 has been deliberately driven over one of the two ends, and the weight of the wheel 100 is off the chock 10. At this point, this leftward shifting of the upper span 12 may be accomplished by hand.

Alternative configurations of the wheel chock are contemplated, and might be useful for wheels of different configurations. For example, the configuration of the chock 110 of FIG. 5 may be used when two wheels 102 and 104 are placed next to each other, such as with a dual-axle trailer and/or semi-tractor and trailer. The wheel chock 110 in the configuration of FIG. 5 is in a loop and has a lower span 114 parallel to, and preferably seating against, the ground with left and right upper spans 112L and 112R placed with at least some of the links seating against the wheels 102 and 104 so that the wheels cannot roll substantially in either direction (left or right in the orientation of FIG. 5) without being obstructed from significant movement by the wheel chock 110. In order for significant rolling to take place, one of the wheels 102 or 104 would have to roll up one of the upper spans 112L or 112R and over the highest point of the chock 110 for the vehicle to roll more than desired. The general shape of the chock 110 does not typically change from what is shown in FIG. 5 during use, but some slight bending may occur if a wheel rolls far onto an upper span due to pivoting between links.

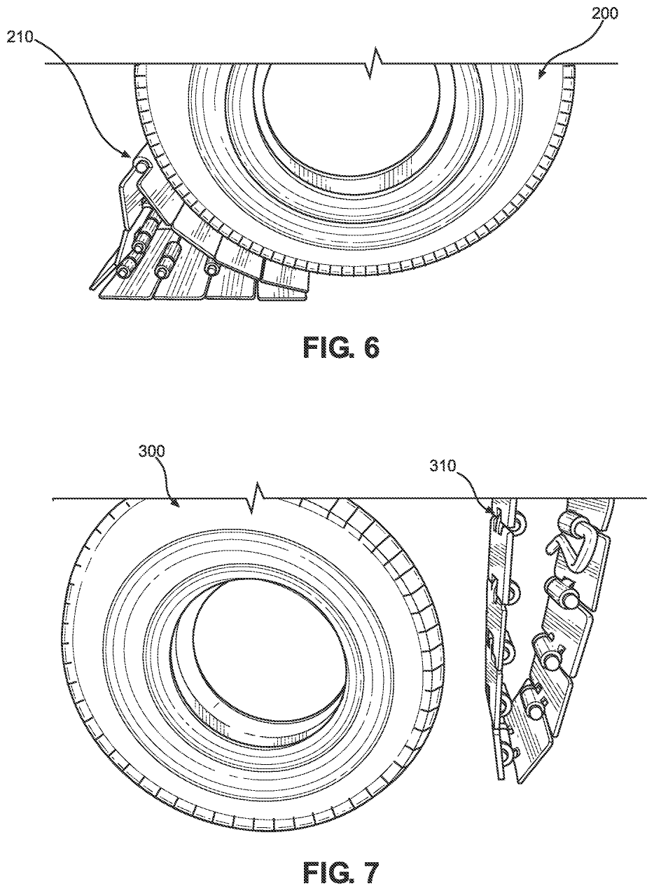

In FIGS. 3B and 6, the chock 210 is in a loop and in still another configuration seated against a wheel 200. The configuration of the chock 210 of FIG. 3B is taller than the configuration of the chock 10 of FIG. 1, thereby making it more difficult for the wheel 200 to roll over the chock 210.

In another alternative shown in FIG. 7, the chock 310 may be positioned directly behind a wheel 300 on a vehicle (not visible) so that the chock 310 may function as a mud flap. Thus, the chock 310 may be mounted to a vehicle frame to be used as a mud flap, and when needed it may be readily removed from the vehicle. The chock 310 may be mounted by two pins, one of which extends through each of two knuckles, similar to the knuckles 24 and 36 shown in FIG. 3 on the chock 10, as well as extending through corresponding knuckles or other structures mounted to the frame of the vehicle to accommodate the attachment. Thus, the chock 310 may be removed from the vehicle by removal of the pins and thus placed under or against the wheel 300 or another wheel in a configuration shown and described herein or any other configuration. Because mud flaps do not typically serve a function when the associated vehicle is at rest or is moving slowly, the invention serves multiple purposes, and may be stored as a mud flap in a convenient location for subsequent use as a wheel chock. Of course, after use in a loop as a wheel chock or unlooped as a traction enhancer, the chock 310 may be re-mounted as a mud flap.

This detailed description in connection with the drawings is intended principally as a description of the presently preferred embodiments of the invention, and is not intended to represent the only form in which the present invention may be constructed or utilized. The description sets forth the designs, functions, means, and methods of implementing the invention in connection with the illustrated embodiments. It is to be understood, however, that the same or equivalent functions and features may be accomplished by different embodiments that are also intended to be encompassed within the spirit and scope of the invention and that various modifications may be adopted without departing from the invention or scope of the following claims.

1. A device combined with a vehicle wheel resting on a surface, the combination comprising:
(a) the device defined by multiple links, each of the links having opposing sides pivotably mounted to other of the links forming a continuous loop including:
(i) a first span including a first group of the links, wherein at least one of the links in the first group is in contact with the surface; and
(ii) a second span including a second group of the links, wherein at least one of the links in the second group is in contact with the wheel and one of the links of the second span is connected to one of the links of the first span.

2. The combination in accordance with claim 1, further comprising a third span including a third group of the links connected between the first span and the second span.

3. The combination in accordance with claim 1, further comprising a third span including a third group of the links, at least one of the links in the third group is in contact with a second wheel of the vehicle.

4. An apparatus configurable to obstruct a wheel on a vehicle, the apparatus comprising:
(a) at least first, second, third and fourth links connected to form a loop, each of the links including:
(i) a plate;
(ii) at least one knuckle on a first side of the plate; and
(iii) at least one knuckle on a second, opposite side of the plate;
wherein the first link is pivotably connected to the second link in the loop by a first pin extending through the at least one knuckle on the second side of the first link and the at least one knuckle on the first side of the second link, and the second link is pivotably connected to the third link in the loop by a second pin extending through the at least one knuckle on the second side of the second link and the at least one knuckle on the first side of the third link.

5. A method of obstructing a vehicle wheel that rests on a surface, the method comprising:
(a) connecting multiple links in series forming a continuous loop, each of the links having opposing sides pivotably mounted to other of the links;
(b) forming a first span including a first group of the links and placing at least one of the links in the first group in contact with the surface; and
(c) forming a second span including a second group of the links and placing at least one of the links in the second group in contact with the wheel.

6. The method in accordance with claim 5, further comprising forming a third span including a third group of the links connected between the first span and the second span.

7. The method in accordance with claim 5, further comprising forming a third span including a third group of the links and disposing at least one of the links in the third group in contact with a second wheel of the vehicle.
